(19) United States
(12) Patent Application Publication
(10) Pub. No.: US 2007/0251974 A1
(43) Pub. Date: Nov. 1, 2007

(54) ERGONOMIC HAND-HELD STAPLER

(75) Inventor: Michael Parrish, Vernon Hills, IL (US)

Correspondence Address: MCNEES WALLACE & NURICK LLC, 100 PINE STREET, P.O. BOX 1166, HARRISBURG, PA, 17108-1166, US

(73) Assignee: ELMER'S PRODUCTS, INC., Columbus, OH (US)

(21) Appl. No.: 11/562,523

(22) Filed: Nov. 22, 2006

Related U.S. Application Data
(60) Provisional application No. 60/745,782, filed on Apr. 27, 2006.

(51) Int. Cl. B25C 5/02

(52) U.S. Cl. 227/134

(57) ABSTRACT

A device for dispensing staples is provided. The device includes a body for holding at least one staple, a lid attached to the body by hinge means, wherein a top surface of the lid further includes a substantially planar surface, a base attached to the body by hinge means, and an actuating lever attached to the base by hinge means, wherein a portion of the actuating lever contacts the substantially planar surface on the lid when the actuating lever is depressed.

### CROSS-REFERENCE TO RELATED APPLICATIONS

This patent application claims the benefit of U.S. Provisional Patent Application Ser. No. 60/745,782 filed on Apr. 27, 2006 and entitled “Ergonomic Hand-Held Stapler,” the disclosure of which is incorporated by reference as if fully rewritten herein.

### BACKGROUND OF THE INVENTION

The present invention relates generally to staplers, and more specifically to an ergonomic, hand-held stapler that includes a lever or actuating arm for actuating the stapler.

Staplers are common items in many households, classrooms, and offices and are commercially available from various sources. A person using a stapler typically sits the stapler on a relatively flat surface, inserts the items to be stapled into the device, and forcibly depresses the top portion of the stapler such that the top portion contacts a portion of the base of the stapler and dispenses a staple into the items being stapled together. Depending on the type of stapler being used, and on the number of items (e.g., pieces of paper) being stapled, the user of the device may have to exert considerable force to actuate the stapler. Furthermore, as multitasking in the office and/or home environment has become more common in recent years, a user of a common stapler may attempt to hold and actuate the stapler with a single hand as they talk on the telephone or perform some other task. Holding and attempting to actuate many commercially available staplers with a single hand can prove ineffective and frustrating because the user of the stapler cannot exert sufficient force to complete the task. Thus, there is a continuing need for a stapler that can be comfortably held in and effectively actuated with a single hand.

### SUMMARY OF THE INVENTION

The following provides a summary of exemplary embodiments of an ergonomic, hand-held stapler according to the present invention. This summary is not an extensive overview and is not intended to identify key or critical aspects or elements of the present invention or to delineate its scope.

In accordance with one aspect of the present invention, a device for dispensing staples is provided. This device includes: a body for holding at least one staple; a lid attached to the body by hinge means, wherein a top surface of the lid further includes a substantially planar surface; a base attached to the body by hinge means; and an actuating lever attached to the base by hinge means, wherein a portion of the actuating lever contacts the substantially planar surface on the lid when the actuating lever is depressed.

In accordance with another aspect of the present invention, a hand-held, ergonomic stapler is provided. This stapler includes: a body for holding staples, wherein the body for holding staples further includes an upper portion hingeably attached to a lower portion and wherein the lower portion further includes a recessed area adapted to receive staples; a lid attached to the body by hinge means, wherein the upper portion of the body is flexibly attached to the lid, and wherein a portion of the top outer surface of the lid further includes a substantially planar surface; a first biasing member disposed between the upper portion of the body and the bottom inner surface of the lid; a base attached to the body by hinge means, wherein the lower portion of the body is flexibly attached to the base; a second biasing member disposed between the lower portion of the body and the top portion of the base; and an actuating lever attached to the base by hinge means, wherein a portion of the underside of the actuating lever contacts the planar surface on the lid, and wherein applying sufficient force to the actuating lever brings the bottom portion of the body into contact with the base and the top portion of the body into contact with the bottom portion of the body, thereby dispensing a staple.

In yet another aspect of this invention, a method for dispensing staples is provided. This method includes providing a hand-held stapler, wherein the hand-held stapler includes the structural and mechanical aspects disclosed above, placing at least one staple in the hand-held stapler, placing at least one item in the stapler, and applying force to the actuating arm, wherein the force is sufficient to bring the bottom portion of the body into contact with the base and the top portion of the body into contact with the bottom portion of the body, thereby dispensing the at least one staple into the item.

Additional features, aspects, and advantages of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a rear perspective view of an exemplary embodiment of the ergonomic hand-held stapler of the present invention.

FIG. 2 is a side view of the stapler illustrated in FIG. 1.

FIG. 3 is a side view of the stapler illustrated in FIG. 1 showing the lever in the forward position for allowing access to the body of the stapler.

FIG. 4 is a top view of the stapler illustrated in FIG. 1 showing the lever in the forward position for allowing access to the body of the stapler.

FIG. 5 is a front/side perspective view of the stapler illustrated in FIG. 1.

### DETAILED DESCRIPTION OF THE INVENTION

Exemplary embodiments of the present invention are now described with specific reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a hand-held, ergonomic stapler, an exemplary embodiment of which includes: a body for holding staples, wherein the body for holding staples further includes an upper portion hingeably attached to a lower portion and wherein the lower portion further includes a recessed area adapted to receive staples; a lid attached to the body by hinge means, wherein the upper portion of the body is flexibly attached to the lid, and wherein a portion of the top outer surface of the lid further includes a substantially planar surface; a first biasing member disposed between the upper portion of the body and the bottom inner surface of the lid; a base attached to the body by hinge means, wherein the lower portion of the body is flexibly attached to the base; a second biasing member disposed between the lower portion of the body and the top portion of the base; and an actuating lever attached to the base by hinge means, wherein a portion of the underside of the actuating lever contacts the substantially planar surface on the lid, and wherein applying sufficient force to the actuating lever brings the bottom portion of the body into contact with the base and the top portion of the body into contact with the bottom portion of the body, thereby dispensing a staple.

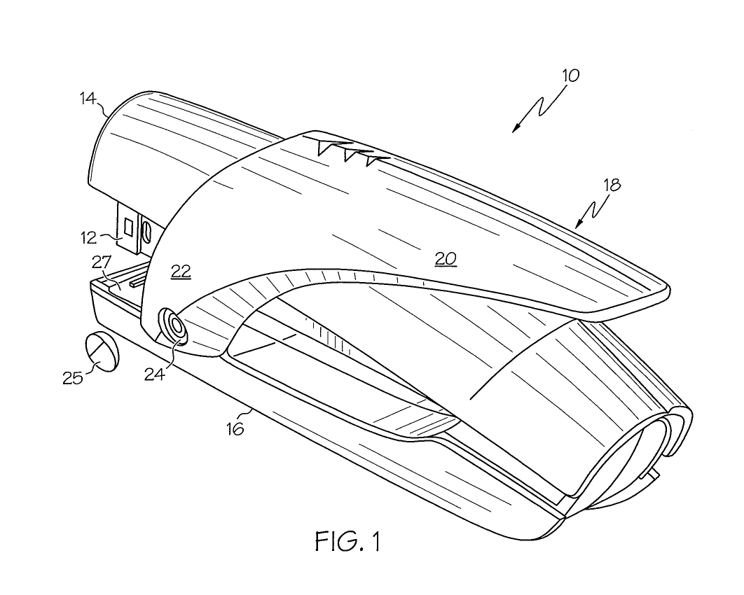

With reference to the Figures, an exemplary embodiment of hand-held stapler 10 includes a separate actuating arm or lever that provides ergonomic features and advantages to the stapler and to a user of the stapler. The exemplary embodiment shown in FIGS. 1-5 includes a body 12 for holding staples, a contoured lid 14 attached the body by hinge means, and a base 16, which is also attached to the body by hinge means. As will be appreciated by those skilled in the art, body 12 typically includes an upper portion attached by a hinge or hinge means to a lower portion. In the exemplary embodiment, the lower portion includes a recessed area adapted to receive staples and the upper portion of body 12 is flexibly and indirectly attached to the bottom surface of lid 14 by a bracket that is fixedly attached to the bottom surface of lid 14. Other attachment means are possible. A first biasing member or spring is mounted between lid 14 and the upper portion of body 12, and a second biasing member is mounted between the lower portion of body 12 and the top portion of base 16. Flexible actuating arm or lever 18 is also attached to base 16 by hinge means and provides a convenient mechanism by which stapler 10 may be more easily actuated with a single hand.

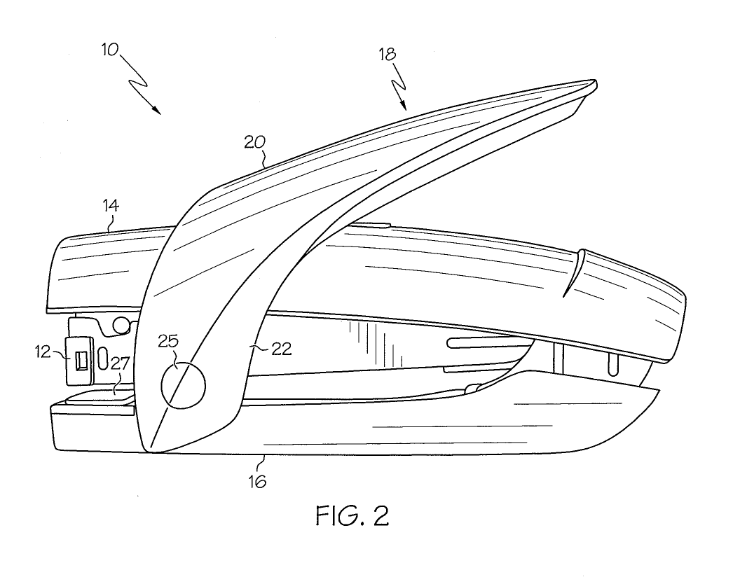

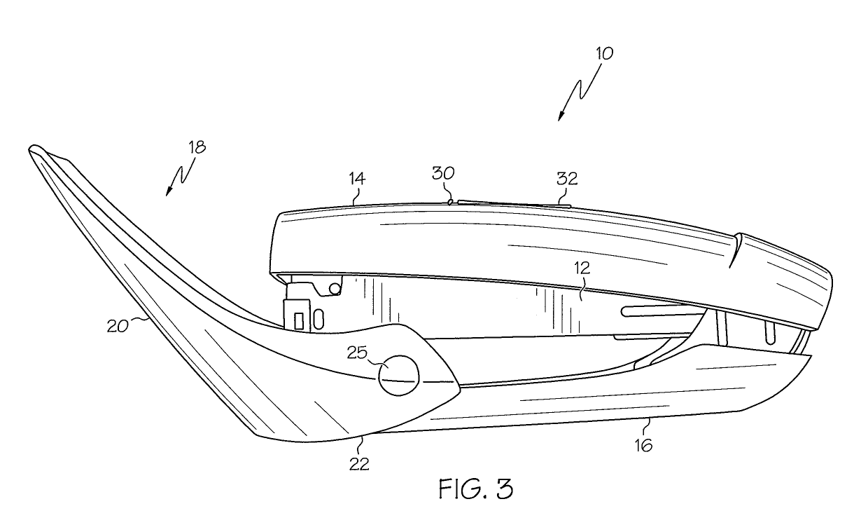

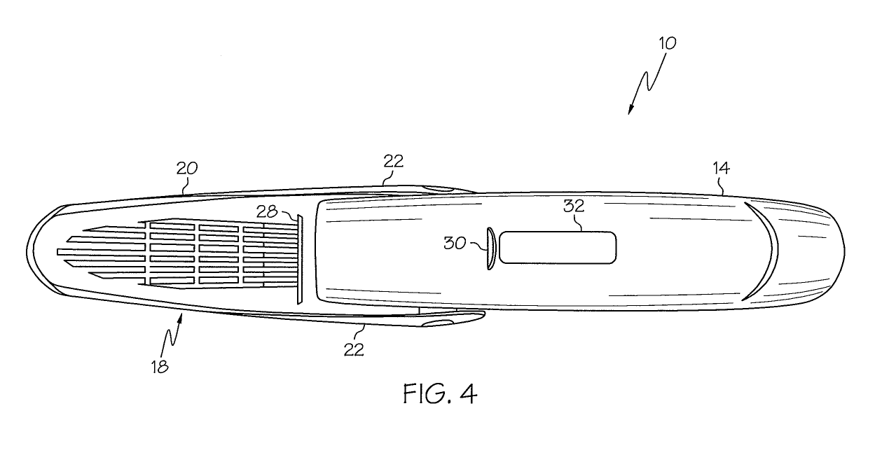

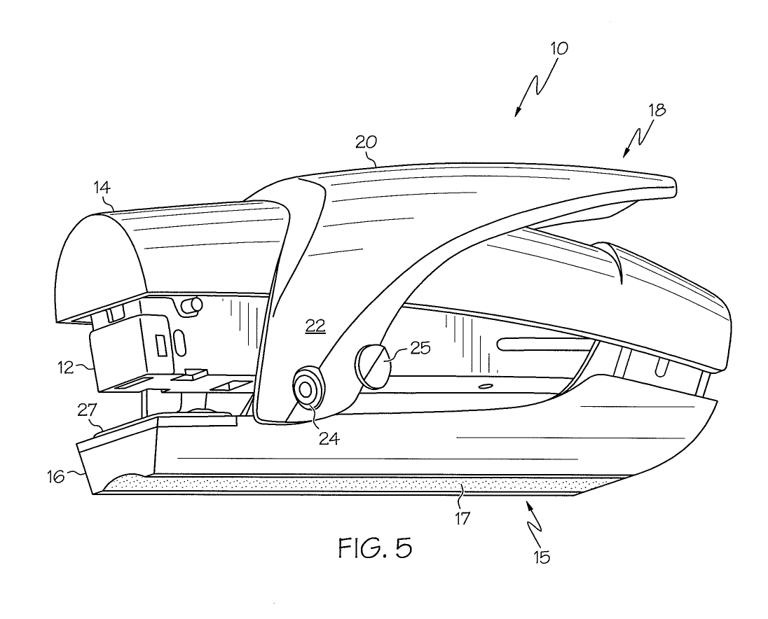

As best shown in FIGS. 2 and 5, lever 18 includes a handle portion 20 and two side portions 22, which are connected to base 16 at hinges 24 and 26. Two button-like protective covers 25 cover the screws or other attachment means by which side portions 22 are connected to base 16. As shown in FIG. 4, the underside of handle portion 20 includes a first ridge or flange 28 that cooperates with at least a portion of the top surface of lid 14 when the present invention is in use. The top surface of lid 14 includes a second ridge or flange 30, and a substantially horizontal planar member 32. When handle portion 20 is positioned over lid 14, the two flanges 28 and 30 cooperate with one another to retain lever 18 in a position appropriate for actuating the stapler. However, the application of sufficient forward force on lever 18 will overcome the resistance provided by the two flanges and allow lever 18 to move or rotate forward (see FIGS. 3-4) so that body 12 may be accessed for purposes of adding staples to stapler 10.

Substantially planar member 32 provides a relatively even and flat surface across which first flange 28 slides when lever 18 is depressed. As lever 18 is depressed and flange 28 moves across the surface of planar member 32, the first and second biasing members, which are mounted between the underside of lid 14 and the top portion of body 12, and the lower portion of body 12 and the top portion of base 16, are compressed. The lower portion of body 12 is compressed against an upwardly biased striker plate 27, lid 14 compresses the upper portion of body 12, the upper portion of body 12 compresses the lower portion of body 12, and a staple is ejected from stapler 10 and into the object or objects to be stapled.

As shown in FIG. 5, the bottom portion 15 of base 16 may include a non-slip texture, surface, or material, which provides gripping means for preventing stapler 10 from sliding across a desktop or tabletop when stapler is actuated on a solid surface. Non-slip material 17 is typically rubber, rubberized plastic, or elastomer, and may be slightly concave in shape so that it can be used as a stable grasping area when stapler 10 is actuated with a single hand. An exemplary method for using hand-held stapler 10 includes: placing at least one staple in the hand-held stapler, placing at least one item in the stapler, and applying force to actuating arm 18 by squeezing the arm or depressing it against lid 14, wherein the force applied is sufficient to bring the bottom portion of the body into contact with base 16 and the top portion of body 12 into contact with the bottom portion of body 12, thereby dispensing at least one staple into the item or items to be stapled.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A stapler, comprising:
(a) a body for holding at least one staple;
(b) a lid attached to the body;
(c) a base attached to the body; and
(d) an actuating lever attached to the base, wherein a portion of the actuating lever contacts a portion of the lid when the actuating lever is depressed, and wherein depressing the actuating lever ejects the at least one staple from the body.

2. The device of claim 1, wherein the body for holding at least one staple further comprises an upper portion attached to a lower portion, and wherein the lower portion is adapted to receive staples.

3. The device of claim 2, further comprising a first biasing member disposed between the upper portion of the body and the lid.

4. The device of claim 2, further comprising a second biasing member disposed between the body and the base.

5. The device of claim 1, wherein the base further comprises at least one of a non-slip material attached thereto and a gripping surface formed integrally therewith.

6. The device of claim 1, wherein the base further comprises an upwardly biased striker plate adapted to cooperate with the body to eject a staple from the body.

7. A device for dispensing staples, comprising:
(a) a body for holding at least one staple;
(b) a lid attached to the body by hinge means, wherein a top surface of the lid further includes a substantially planar surface;
(c) a base attached to the body by hinge means; and
(d) an actuating lever attached to the base by hinge means, wherein a portion of the actuating lever contacts the substantially planar surface on the lid when the actuating lever is depressed.

8. The device of claim 7, wherein the body for holding at least one staple further comprises an upper portion attached to a lower portion, and wherein the lower portion is adapted to receive staples.

9. The device of claim 8, further comprising a first biasing member disposed between the upper portion of the body and the lid.

10. The device of claim 8, further comprising a second biasing member disposed between the body and the base.

11. The device of claim 7, wherein the base further comprises at least one of a non-slip material and a gripping surface attached thereto or formed integrally therewith.

12. The device of claim 7, wherein the base further comprises a striker plate adapted to cooperate with the body to eject a staple from the body.

13. A hand-held, ergonomic stapler, comprising:
(a) a body for holding staples, wherein the body for holding staples further includes an upper portion hingeably attached to a lower portion and wherein the lower portion further includes a recessed area adapted to receive staples;
(b) a lid attached to the body by hinge means, wherein the upper portion of the body is flexibly attached to the lid, and wherein a portion of the top outer surface of the lid further includes a substantially planar surface;
(c) a first biasing member disposed between the upper portion of the body and the bottom inner surface of the lid;
(d) a base attached to the body by hinge means, wherein the lower portion of the body is flexibly attached to the base;
(e) a second biasing member disposed between the lower portion of the body and the top portion of the base; and
(f) an actuating lever attached to the base by hinge means, wherein a portion of the underside of the actuating lever contacts the planar surface on the lid, and wherein applying sufficient force to the actuating lever brings the bottom portion of the body into contact with the base and the top portion of the body into contact with the bottom portion of the body thereby dispensing a staple.

14. The stapler of claim 13, further comprising at least one of a non-slip material attached to the base and a gripping surface formed on the base.

15. The stapler of claim 13, wherein the top surface of the lid further comprises first flange and the bottom surface of the actuating lever further comprises a second flange, and wherein the first and second flanges cooperate with one another to maintain the actuating arm in a position appropriate for actuating the stapler.

16. The stapler of claim 13, wherein the base further comprises at least one plate adapted to cooperate with the body for ejecting a staple from the body.

17. The stapler of claim 13, wherein the actuating arm further comprises a first side portion for attaching to the left side of the base, and a second side portion for attaching to the right side of the base.

18. A method for dispensing staples, comprising:
(a) providing a hand-held stapler, wherein the hand-held stapler further comprises:
(i) a body for holding staples, wherein the body for holding staples further includes an upper portion hingeably attached to a lower portion and wherein the lower portion further includes a recessed area adapted to receive staples;
(ii) a lid attached to the body by hinge means, wherein the upper portion of the body is moveably attached to the lid, and wherein a portion of the top outer surface of the lid further includes a substantially planar surface;
(iii) a first biasing member disposed between the upper portion of the body and the bottom inner surface of the lid;
(iv) a base attached to the body by hinge means, wherein the lower portion of the body is moveably attached to the base;
(v) a second biasing member disposed between the lower portion of the body and the top portion of the base; and
(vi) an actuating lever attached to the base by hinge means, wherein a portion of the underside of the actuating lever contacts the planar surface on the lid; and
(b) placing at least one staple in the hand-held stapler;
(c) placing at least one item in the stapler; and
(d) applying force to the actuating arm, wherein the force is sufficient to bring the bottom portion of the body into contact with the base and the top portion of the body into contact with the bottom portion of the body, thereby dispensing the at least one staple into the item.

19. The method of claim 18, wherein the stapler further comprises at least one of a non-slip material attached to the base and a gripping surface formed on the base.

20. The method of claim 18, wherein the top surface of the lid further comprises first flange and the bottom surface of the actuating lever further comprises a second flange, and wherein the first and second flanges cooperate with one another to maintain the actuating arm in a position appropriate for actuating the stapler.
